(19) United States
(12) Patent Application Publication
(10) Pub. No.: US 2004/0188342 A1
(43) Pub. Date: Sep. 30, 2004

(54) Filter

(76) Inventors: Brian Bellhouse, Oxford (GB); George Costigan, Oxford (GB)

Correspondence Address: BAKER & DANIELS, 111 E. WAYNE STREET, SUITE 800, FORT WAYNE, IN, 46802

(21) Appl. No.: 10/469,662

(22) PCT Filed: Mar. 1, 2002
(86) PCT No.: PCT/GB02/00893

(30) Foreign Application Priority Data
Mar. 2, 2001 (GB) 0105247.1

(51) Int. Cl. B01D 63/10

(52) U.S. Cl. 210/321.85; 210/321.88; 210/321.89; 210/512.1

(57) ABSTRACT

A filter comprising one or more substantially unobstructed ducts (11), each with a longitudinal axis. Each duct has a porous wall which defines a lumen (17) that is surrounded by a helical groove (18) in the respective wall. The ratio of the cross sectional areas, when taken perpendicular to the longitudinal axis, of the totally unobstructed lumen of the duct to that of the open area of the duct, incorporating the helical groove and the lumen, governs the magnitude of the velocities of the fluid flow in the duct. The value of this ratio must allow these velocities to be sufficient to develop a level of interaction between the flow along the groove and the flow through the lumen that produces a flow pattern having a substantially continuous vortex (23), the axis of which is helical.

This invention relates to filters, particularly, though not exclusively, for medium-scale applications such as water purification or food processing.

Filters which have a large membrane area packed into a small volume for larger applications are available commercially. One such filter provides a large number of parallel capillaries, in a highly porous block of support material such as a ceramic, with a much tighter porous layer at the wall of each capillary. The manifolding of the capillaries for feed fluid entry and exit is provided by the porous block. Filtrate passes through the capillary walls and then through the highly porous block. The filtrate is then collected in suitable channels at the outer surface of the porous block. However, it is necessary to pump the feed flow through each capillary at velocities as high as 6 m/s in order to achieve reasonable mixing by turbulent flow and hence adequate filtration performance. Although this design is space-saving it requires very high flow rates, and hence pumping costs (both capital and running) are correspondingly high. Furthermore, damage to delicate components in the feed fluid, caused by turbulent flow is an additional disadvantage of this particular method.

One way of reducing the feed flow rate would be to place helical inserts in each tubular capillary in the porous ceramic block. Indeed, an example of a prior art filter in this field is a rod with a helical groove inserted concentrically within a tubular filtration membrane. Steady feed flow in the annular space between the impermeable helical insert and the concentric tubular permeable membrane provides excellent radial mixing. In a second example, the tubular filtration membrane lies concentrically inside a casing containing a helical groove. Flow patterns are created within the annular space between the impermeable casing and the cylindrical permeable membrane, which ensure high filtration performance and good mixing which prevents concentration polarisation. Both of these examples work well with a polymeric, permeable, membrane tube of diameter 12.5 mm, but it is difficult to scale up these apparatuses to provide membrane areas of the order of 1 to 10 m² for larger applications without resorting to bulky and expensive filter units. Also it can be desirable to form capillaries with a diameter of 4 mm or less, and it is difficult to construct helical inserts of suitable geometry which are sufficiently robust and which are sufficiently rigid to avoid vibration and consequent damage to the capillary walls.

According to the present invention, there is provided a filter comprising one or more substantially unobstructed ducts, each duct having a longitudinal axis and a porous wall defining a lumen surrounded by a helical groove in the respective wall, wherein, the ratio of the cross sectional areas, when taken perpendicular to the longitudinal axis, of the totally unobstructed lumen of the duct to that of the open area of the duct, incorporating the helical groove and the lumen, is such that the velocities of fluid flow in the duct, in use, are sufficient to develop a level of interaction between the flow along the groove and the flow through the lumen that produces a flow pattern having a substantially continuous vortex, the axis of which is helical.

Unlike prior art filters, in which the porous membrane is of a cylindrical shape, the porous surface in this invention is of a helical shape. The helically grooved ducts thus provide excellent radial mixing and hence prevent concentration polarisation, but also provide increased membrane area, compared with conventional permeable membranes of circular cross-section. The present invention also avoids the high pumping costs of prior art filters and the difficulty and expense of constructing helical inserts which can cause vibration and damage to cylindrical membrane walls.

Fluid to be filtered is passed into the lumen which is bounded by a wall with a helical groove formed in it. This defines a helical path for the fluid flowing in the filter which, in turn, induces centrifugal forces within the flow. A further component of motion is introduced into this helical flow. This secondary motion has been found to give much improved flushing of the filter surface whilst at the same time maintaining substantially laminar flow to prevent damage to the particulate components in the fluid being filtered, therefore shear sensitive fluids can be handled (eg. blood cells).

This secondary motion in the helical flow is caused by phenomena such as Dean vortices. As the lumen diameter is modified with respect to the helix diameter, the axial velocity will be affected and the Dean vortices can become asymmetric. The stronger upstream vortex can dominate the weaker downstream one to the extent that a single vortex may be seen. This enhances the mixing properties of the flow and helps to bring the fluid into maximum contact with the filter surface, thus significantly improving the performance of the filter.

The limiting value of the magnitude of the lumen is governed by this level of entrainment/interaction. The relative dimensions of the filter may be determined such that the magnitude of the cross sectional area of the lumen does not exceed 35% of that of the total open cross sectional area (incorporating the lumen and the grooves), when these cross sections are taken perpendicular to the longitudinal axis of the filter.

The current invention is restricted to a maximum of three starts to the groove to achieve a compromise between the axial pressure drop experienced and effectiveness of the Dean vortices. The ratio of the longitudinal diameter of the groove to the diameter of the lumen remains constant, irrespective of the number of starts of groove. The grooves may be semicircular in cross section when taken parallel to the longitudinal axis of the filter.

The lumen of the duct may be up to 20 mm in diameter, but is preferably between 2 and 5 mm in diameter with adjacent turns separated by a land, that is for example, substantially 0.5 mm wide.

As seen in cross section perpendicular to the longitudinal axis, the peripheral wall of the groove may be arcuate to promote a smooth flow pattern and an appropriate cross sectional shape is semi circular.

The duct is preferably in a porous block of support material, and a denser porous surface may be formed at the wall of the duct.

The porous block lends itself to the possible formation of a large number of ducts therein to create a large membrane area in a small volume for more efficient filtering. The filtrate may be conveniently collected in a chamber or chambers at the outer surface of the porous block.

In the accompanying drawings:

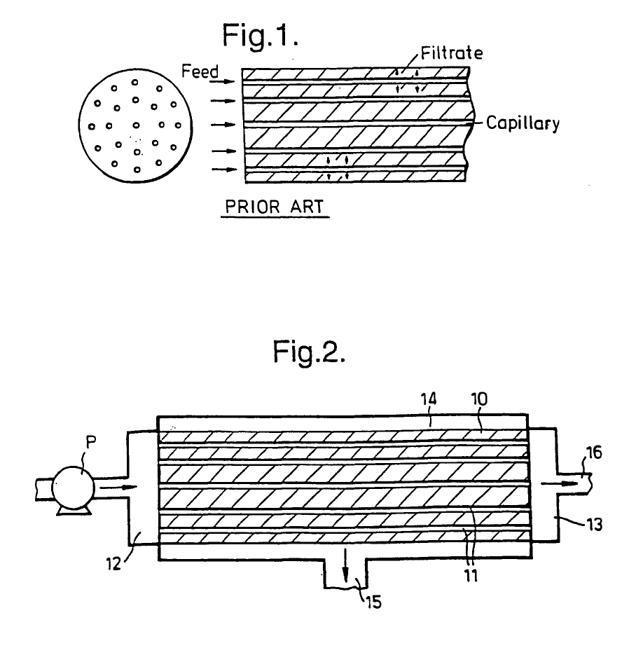

FIG. 1 is an example of a porous ceramic block containing capillaries according to the prior art;

FIG. 2 is a diagrammatic representation of how the filter may be used;

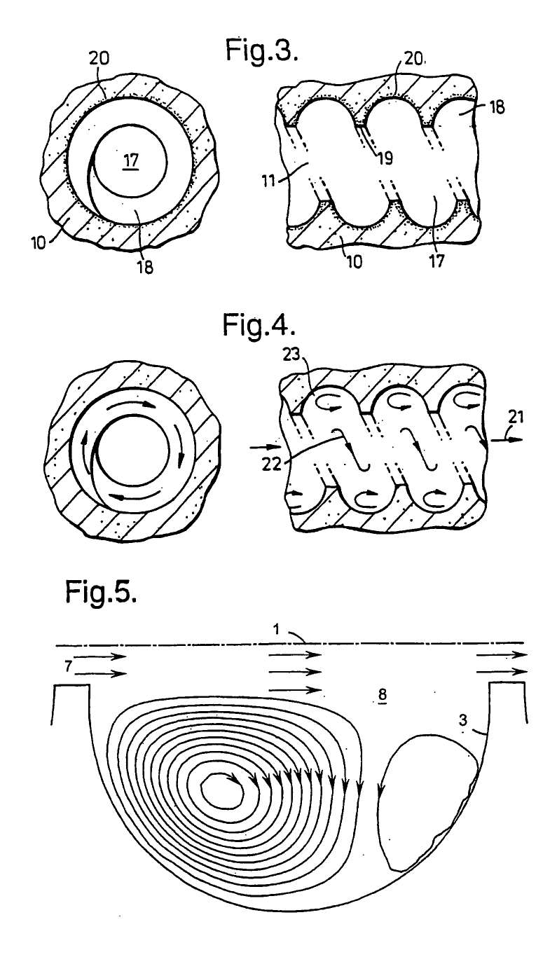

FIG. 3 is an axial section showing diagrammatically the typical geometry of a duct according to the present invention;

FIG. 4 illustrates the flow patterns present in the duct of FIG. 3;

FIG. 5 illustrates the vortex patterns in the cross section of the helical groove in detail;

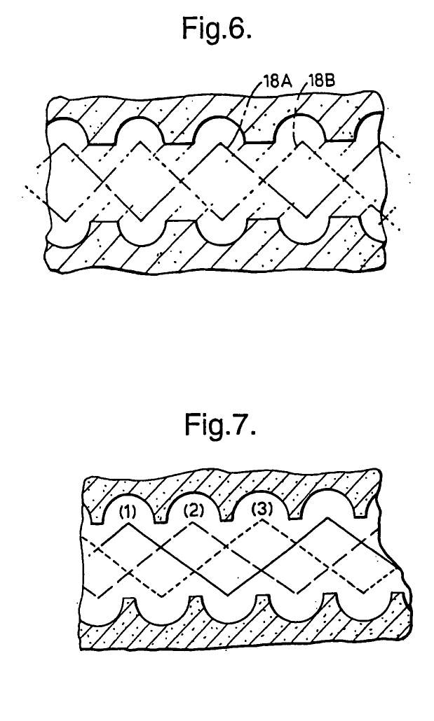

FIG. 6 is a diagrammatic axial section of a duct having a double-start groove; and,

FIG. 7 is a diagrammatic axial section of a duct having a triple-start groove.

FIG. 1 illustrates a prior art filter of the type 35 described above.

As shown in FIG. 2, a porous block 10 of sintered material is formed with a number of longitudinal ducts 11.

At an upstream end of the block these ducts open into an inlet manifold 12 and, at the downstream end, into an outlet manifold 13. The block is surrounded by an annular chamber 14 having an outlet 15. In use a fluid to be filtered is forced by a pump P into the inlet manifold 12 and hence through the ducts 11. The filtrate passes out through the walls of the ducts and percolates through the pores in the block 10 until it reaches the chamber 14, from which it is recovered through the outlet 15. The concentrate of the filtration passes into the outlet manifold 13 and hence through an outlet 16.

FIGS. 3 and 4 show the internal geometry of a duct 11. This is shown as having a cylindrical lumen 17 surrounded by a single-start helical groove 18 of substantially semicircular cross-section, with adjacent turns separated by a land 19.

As described elsewhere, the wall of the duct may have a layer 20 of more dense porous material.

The secondary flow patterns produced when the duct is in use are shown in FIG. 4. Core flow 21 is through the lumen with the helical flow 22 around the groove producing vortices 23, ensuring good mixing and high filtration performance.

FIG. 5 illustrates the action of the flow through the lumen on the flow in the groove. The diagram has been prepared using mathematical modelling techniques and the density of lines is intended as a measure of the strength of the flow in the direction indicated. The action of the high velocity flow through the lumen is to overwhelm the pre-existing downstream Dean vortex and reinforce the upstream vortex. In perfect conditions the downstream vortex will be reduced to zero and the flow through the groove will represent a single corkscrew vortex which constantly entrains material from the axial flow through the lumen. The action of the vortex is twofold: firstly to scour the surface of the filter to keep it clear of entrained solids, secondly to retain those entrained solids in suspension so that they are carried out of the filter by the fluid flow.

FIG. 6 shows a modification of the duct of FIG. 3, in which there is a double-start groove 18 (A) and 18(B).

FIG. 7 shows a further modification of the duct of FIG. 3, in which there is a triple-start groove.

The porous blocks with helically grooved ducts within them could be made by a technique adapted from the well-known process for making ceramic filters with cylindrical capillaries according to the prior art.

In this process, a tubular metal container has the required number of duct defining rods fixed within it. The duct defining rods of the present invention have helical formations projecting therefrom and are screwed into the top and bottom end plates of the metal container. Particulate clay in dry or slurry form or glass or other ceramic or polymeric material is introduced into the space between the duct defining rods. When filled, the container is heated in an oven to the temperature required to fire the clay or other porous material. When the fired block has cooled, the duct defining rods are unscrewed from the porous block and the block is retracted from the metal container. The duct defining rods and/or the metal container may be slightly tapered to improve release.

A denser porous surface may then be applied to the walls of the ducts. This can be done using a slurry of clay or other particles of much smaller size than those used to make the highly porous block. Dip-coating, spin-coating or slip-coating techniques are familiar to ceramic and polymeric membrane manufacturers, any of which could be used to apply the tighter membrane surface. The pores produced should have a diameter of about 0.2 μm for micro filtration, 0.02 μm for ultra filtration or 0.002 μm for nano filtration.

All three types of pore size are useful in food and water processing. Dye processing would use mainly nano filtration. Ceramic materials can be cleaned with aggressive chemicals and can be steam sterilised, both important advantages for food or water processing.

An alternative method of manufacture would be to extrude ceramic tubes with helical geometry. These could be extruded singly and then assembled in parallel into a stack. Alternatively, they could be co-extruded with rotating extruder heads.

As an alternative to ceramic or sintered materials, it should be possible to inject open pore structural foam materials, such as polyurethane, to form the porous block. Dip-coating of the tubular walls with polymeric solutions, preferably prior to injection of the structural foam, provides the selective membrane surfaces. Pore size is often controlled either by dissolving particulates such as salt or by solvent exchange (also known as phase inversion).

In the production of polymeric membranes it is often possible to provide a skinned, or asymmetric structure, with the skin forming at a solid surface, such as the surface of the duct-defining metal rods used in the present invention. Thus it should be possible to form the whole block with a single injection of polymeric open-pored foam. Although polymer foams would be difficult to clean and sterilise they may offer big savings in cost, compared to ceramic membranes.

1. A filter comprising one or more substantially unobstructed ducts, each duct having a longitudinal axis and a porous wall defining a lumen surrounded by a helical groove in the respective wall, wherein, the ratio of the cross sectional areas, when taken perpendicular to the longitudinal axis, of the totally unobstructed lumen of the duct to that of the open area of the duct, incorporating the helical groove and the lumen, is such that the velocities of fluid flow in the duct, in use, are sufficient to develop a level of interaction between the flow along the groove and the flow through the lumen that produces a flow pattern having a substantially continuous vortex, the axis of which is helical.

2. A filter according to claim 1, wherein the groove is a triple start groove.

3. A filter according to claim 1, wherein the groove is a double start groove.

4. A filter according to claim 2 or claim 3, wherein the ratio of the cross sectional areas of the lumen of the duct to that of the open area of the duct has a maximum value of 35:100.

5. A filter according to any of the preceding claims, wherein Dean vortices are the mechanism for interaction between the flow along the groove and the flow through the lumen.

6. A filter according to any of claims 1 to 5, wherein a denser surface is formed at the walls of the duct.

7. A filter according to any of claims 1 to 6, further comprising a chamber for collecting filtrate.

8. A filter according to any preceding claim, wherein the lumen has a diameter of up to 20 mm.

9. A filter according to any of claims 1 to 7, wherein the lumen has a diameter of between 2 and 5 mm.
